(19) United States
(12) Patent Application Publication
(10) Pub. No.: US 2004/0089486 A1
(43) Pub. Date: May 13, 2004

(54) Vehicle power storage by hydrolysis of water

(76) Inventors: Clive Harrup, Bromham (GB); Dennis A. Kramer, Troy, MI (US); Mehmet S. Ciray, Greenwood, IN (US); Dean Mark House, Pataskala, OH (US); David K. Platner, Shelby, MI (US); Dale J. Eschenburg, Clinton Township, MI (US); Dale K. Bell, Ortonville, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/293,768

(22) Filed: Nov. 13, 2002

(51) Int. Cl. B60K 6/04

(52) U.S. Cl. 180/65.3

(57) ABSTRACT

A power producing assembly for a vehicle includes a generator to control energy produced during movement of the vehicle and a hydrolysis system powered by electrical energy produced by the generator to separate water into hydrogen and oxygen. Hydrogen and oxygen are then routed to a fuel cell to produce electrical energy. Hydrogen may also be used in a combustion engine which bums the hydrogen gas. Gases used by the energy producing fuel cell or combustion engine are recovered and recombined to form water for reuse by the hydrolysis system.

### BACKGROUND OF THE INVENTION

This invention relates to an assembly and method for power storage and recovery in an electric vehicle, and specifically to an assembly and method of power storage and recovery utilizing hydrolysis of water to produce hydrogen and oxygen.

Current interest in the development of alternate energy sources has renewed activity in the development of a practical electric powered vehicle. Electric power vehicles are of great interest because of current efforts to reduce air pollution and conserve fuel resources. Increased efforts are directed at increasing the duration in which an electric powered vehicle can operate between charging. As appreciated, electric powered vehicles are powered by an electric motor supplied energy from a power storage device. Typically, the power storage device is a bank of batteries disposed within the vehicle. The batteries are periodically charged to renew energy stored within the batteries. Current battery technology requires battery charging after short periods of operation. Short periods of operation restrict the range of the electric powered vehicle and are one reason for the current limited acceptance of electric powered vehicles.

Alternate power storage devices such as fuel cells provide some improvement over traditional banks of batteries stored within a vehicle. However, such fuel cells also require a supply of fuel and a power source in which to operate. A fuel cell is a demand type power system that operates in response to a load. A liquid reformer converts hydrogen in liquid form into a gas used by the fuel cell. Typically, a liquid hydrogen containing fuel is converted to a hydrogen gas to power the fuel cell. The liquid fuel also contains other gases such as carbon monoxide, carbon dioxide, methane, water vapor, and various other components. An oxidant such as air is also supplied to the fuel cell to react with the hydrogen fuel and produce an electric current. Electric current is then drawn on demand in response to loads across the fuel cell exerted by the electric motor.

In some electric vehicles, the electric motor also provides a retarding force during slowing or stopping of the vehicle. During the slowing or stopping of the vehicle it is known to operate the electric motor to generate electrical energy and store that electrical energy within a storage device mounted within the vehicle. Most often the energy storage device is a battery. As is appreciated, during downhill runs or stopping of the motor vehicle, a great deal of energy is produced and is released as heat unless somehow otherwise stored. In conventional internal combustion engines the energy is simply dissipated as heat into the atmosphere. It is known in electric vehicles to harness this energy and store it as electricity within batteries within the motor vehicle.

Hydrolysis of water is a known process that produces hydrogen and oxygen gas. Hydrogen and oxygen provide components to power a fuel cell and produce an electric current. Hydrolysis of water requires electricity to separate water into hydrogen and oxygen.

Accordingly, it is desirable to design a system for use in an electric vehicle that can store and recover energy to increase a practical range of the electrically powered vehicle.

### SUMMARY OF THE INVENTION

An embodiment of this invention is an assembly and method of storing and recovering energy within an electric vehicle through hydrolysis of water to provide hydrogen and oxygen for use in an energy producing or storing system.

An embodiment of this invention is a assembly and method for producing and storing energy produced by an electric vehicle during excess energy events or during changing of the vehicle. The system includes the hydrolysis of water into its component parts, hydrogen and oxygen. The separated hydrogen and oxygen is then provided to a power producing system to produce energy for the vehicle.

In one embodiment of this invention, hydrogen and oxygen produced through hydrolysis of water is routed to a fuel cell. The fuel cell produces electrical energy by way of a chemical reaction between the hydrogen and oxygen. Energy to perform the hydrolysis operation to separate hydrogen gas from oxygen is provided by electrical energy produced during braking. Such energy would otherwise dissipate into the atmosphere as heat and be lost. In this embodiment, the motor generates electricity in response to braking actions or retarding actions of the vehicle such as when the vehicle is proceeding down a hill. This electric energy is routed to the hydrolysis system in order to convert water into its component parts hydrogen and oxygen. The hydrogen and oxygen is then used within a fuel cell that reacts the two components to produce electrical energy. The electrical energy can then either be stored within batteries of the motor vehicle or directly routed to the electric motor to drive the vehicle.

In another embodiment of this invention hydrogen gas emitted from the hydrolysis system is routed to a combustion engine to provide fuel in the combustion process. The combustion engine then may drive a generator which in turn produces electricity that can be routed to systems on the motor vehicle including the electric motor driving the vehicle.

Accordingly, the system of this invention provides an assembly and method of recovering and utilizing energy by way of a hydrolysis reaction that provides hydrogen and oxygen components for use in power generating systems on board the vehicle.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a schematic view of an electric vehicle including the system for storing energy;

FIG. 2 is an embodiment of this invention where the electric motor and combustion engine are configured in series; and

FIG. 3 is an embodiment of this invention where the electric motor and combustion engine are configured in parallel.

### DETAILED DESCRIPTION OF THE PREFERRED EMBODIMENT

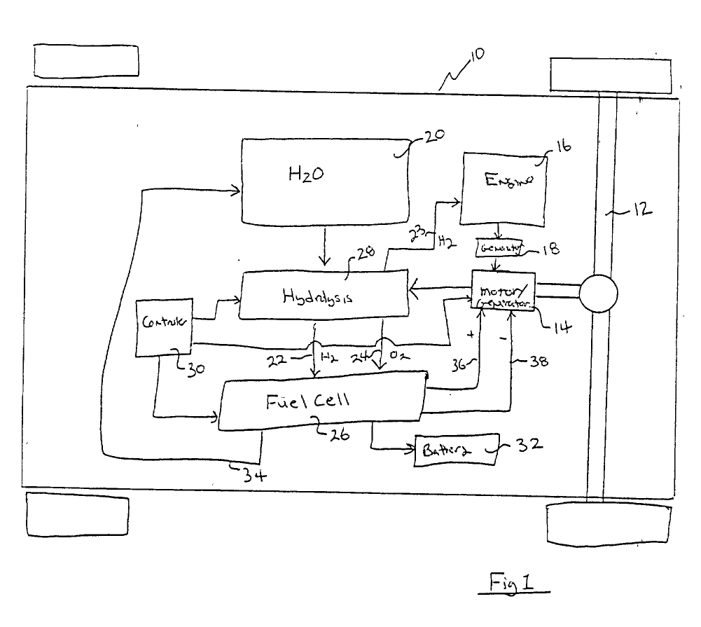

Referring to FIG. 1, an electric vehicle 10 is schematically shown including a driveline 12 powered by an electric motor 14. The electric motor 14 maybe of any type known to a worker skilled in the art. Further, the electric motor 14 may also be controlled by a controller 30 for use as a generator in instances where the vehicle 10 is being braked or movement is being retarded such as when the vehicle 10 is proceeding down an incline.

The electric motor 14 is powered by electrical energy provided either through a fuel cell 26 or a bank of batteries 32. The specific configuration of electricity routed to drive the electric motor 14 is of any type known to a worker skilled in the art. A water source 20 feeds a hydrolysis system 28. Hydrolysis is a reaction where electrical energy is used to separate elements of a gas or a liquid such as water. The hydrolysis system 28 of this invention uses electrical energy to separate hydrogen and oxygen supplied from the water supply 20. Water is separated in the hydrolysis system 28 into hydrogen gas 22 and oxygen 24. These two gases are then separated and routed to power producing systems in the vehicle 10.

A fuel cell 26 converts a gaseous fuel in the presence of an oxidant into electrical energy. Fuel cells are on demand type storage devices such that they produce electrical energy in response to demands for electrical energy such as from the electrical motor 14. In this invention, the fuel cell 26 is supplied with hydrogen gas 22 from the hydrolysis system 28. The hydrogen gas 22 combines within the fuel cell 26 with oxygen 24, also provided from the hydrolysis system 28, to produce an electrical current that is either used to charge a bank of batteries illustrated at 32, or is connected directly to the electric motor 14 to drive the vehicle 10. The fuel cell 26 includes a positive lead 36 and a negative lead 38 that is directly connected to the electric motor 14.

A controller 30 is in communication with the fuel cell 26, the hydrolysis system 28 along with the motor 14. As energy is produced through the reclaiming of excess energy such as during braking or retarding of the vehicle 10, this excess energy is used by the hydrolysis system 28 to separate water 20 into its component parts, hydrogen gas 22 and oxygen 24. The hydrogen gas 22 and oxygen 24 is then used by the fuel cell 26 to produce electricity that can be used by other vehicle systems.

As appreciated, this system recovers energy that would otherwise be dissipated into the atmosphere as heat during braking processes of the vehicle 10. Further, not only can excess energy events supply the electrical energy needed by the hydrolysis system 28 to separate hydrogen and oxygen, it is also within the contemplation of this invention that the hydrolysis of water is powered during periodic charging of the vehicle 10. When the hydrolysis system 28 is powered by a stationary charging device such that hydrogen and oxygen are separated and stored until required by the fuel cell 26 during vehicle operation.

Although the schematic illustration shows a direct line from the hydrolysis system 28 of hydrogen gas 22 to the fuel cell 26, it is also within the contemplation of this invention that the separated components, hydrogen gas 22 and oxygen 24, be stored in separate containers for use on demand during the operation of the vehicle 10.

In another embodiment of this invention, hydrogen gas shown at 23 is routed to a combustion engine 16. The combustion engine 16 in turn drives a second generator 18 to produce electricity used to power the vehicle 10. In this embodiment the energy producing unit is the engine 16 and power from the generator 18 is either routed directly to the motor 14 or it can also be routed to batteries 32 for storage.

During reserve charging periods or excessive energy events, like stopping or downhill runs, recovered electricity is used to convert water into hydrogen and oxygen by hydrolysis. The gases are stored for use in the fuel cell 26 or for use in the combustion engine 16. The exhaust material from the energy producing systems, the engine 16 and fuel cell 26, are recovered and stored, as water after being recombined. The hydrolysis system 28 may replace, or supplement batteries 32 to supply electric energy that can continually be maintained and charged during vehicle operation 10.

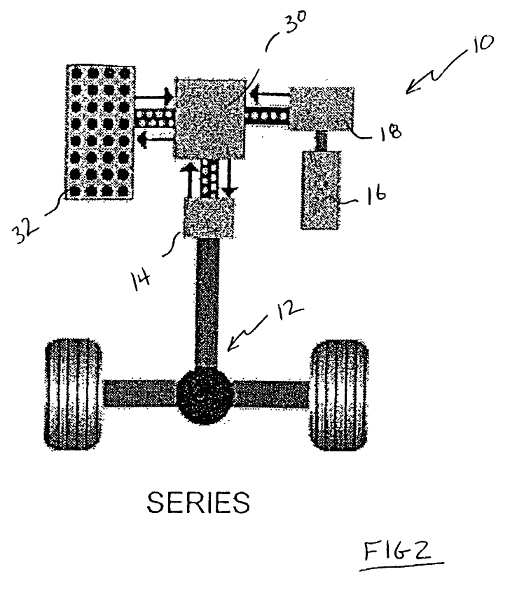

Referring to FIG. 2, in one embodiment of this application the electric motor 14 is configured in series with an internal combustion engine 16. In this configuration, the internal combustion engine 16 drives a generator 18. The generator 18 in turn provides electrical energy for use by the electric motor 14. Fuel for the internal combustion engine 16 can either be provided by a fuel storage container or from the hydrolysis system 28. As appreciated, the hydrolysis system 28 may act as an auxiliary energy storage device which recovers excess energy instead of allowing excess energy to dissipate as heat into the atmosphere. In this embodiment, electricity generated by the second generator 18 may also be used to charge a bank of batteries 32.

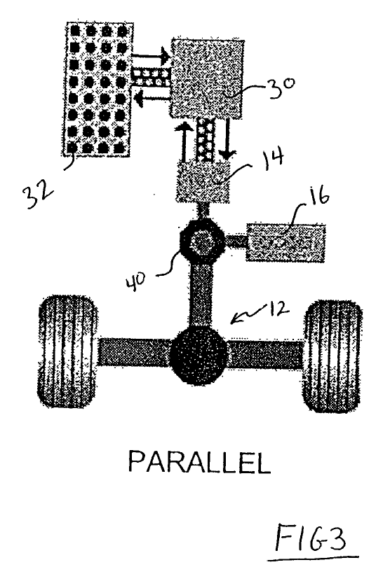

Referring to FIG. 3, another configuration of an electric vehicle is shown. In this configuration, the electric motor 13 is coupled to a mechanical coupling 40. The mechanical coupling 40 is also coupled to a combustion engine 16. Either the motor 14 or combustion engine 16 can drive the driveline 12 of the vehicle 10. In this configuration, the combustion engine 16 can operate during times of peak power requirements and the electric motor 14 can operate during times of steady or lower power requirements.

In either configuration, the hydrolysis system of this invention recovers energy otherwise dissipated as heat into the atmosphere. The hydrolysis system 28 provides the hydrogen fuel used in the fuel cell 26. It is within the contemplation of this invention that the fuel cell 26 may be of any configuration as is known to worker skilled in the art. Further, energy produced by the fuel cell 26 may be used by any system mounted within the vehicle 10.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason the following claims should be studied to determine the true scope and content of this invention.

What is claimed is:

1. A power recovery assembly for a vehicle comprising;
a generator controlled to recover energy produced during movement of the vehicle;
a hydrolysis system powered by said generator for converting water into hydrogen and oxygen;
an energy producing system transforming at least one of said hydrogen and oxygen into energy.

2. The assembly of claim 1, wherein said generator is engaged to a drive assembly of the vehicle.

3. The assembly of claim 1, wherein said generator is operatively associated with a braking system of the vehicle.

4. The assembly of claim 1, wherein said energy producing system is an internal combustion engine.

5. The assembly of claim 1, wherein said energy producing system is a fuel cell.

6. The assembly of claim 5, wherein said fuel cell provides electrical energy to systems within said vehicle.

7. The assembly of claim 1, wherein said hydrogen and oxygen are recovered and recombined to form water.

8. The assembly of claim 1, wherein said hydrolysis system includes storage containers for said hydrogen and said oxygen separated during hydrolysis.

9. The assembly of claim 1, including an energy storage device, a combustion engine, and an electric motor.

10. The assembly of claim 9, wherein said electric motor and combustion engine are mechanically coupled in a parallel configuration to a vehicle drive train such that said electric motor and said combustion engine selectively drives said drive train independent of each other.

11. The assembly of claim 9, wherein said combustion engine drives a second generator for producing electrical energy to drive said electric motor and said electric motor drives a vehicle drive train.

12. The assembly of claim 9, wherein said energy storage device is a fuel cell.

13. The assembly of claim 9, further including a controller in communication with said hydrolysis system, said generators, said electric motor, and said combustion engine to control operation.

14. A method of producing energy within a vehicle comprising the steps of;
a.) converting excess energy into electrical energy;
b.) separating water into hydrogen and oxygen through hydrolysis using said electrical energy; and
c.) supplying at least one of said hydrogen and oxygen to an energy producing system.

15. The method of claim 14, further including the step of producing energy with said energy producing system for use in the vehicle.

16. The method of claim 14, wherein said hydrogen and oxygen are supplied to a fuel cell to produce electrical energy.

17. The method of claim 14, wherein at least one of said hydrogen and oxygen are supplied to a combustion engine.

18. The method of claim 14 further including the step of recovering hydrogen and oxygen after use by said energy producing system, and recombining said hydrogen and oxygen into water.
